(19) United States
(12) Patent Application Publication
(10) Pub. No.: US 2024/0328668 A1
(43) Pub. Date: Oct. 3, 2024

(54) CONVECTION-CONTROLLED STORAGE WATER HEATING

(71) Applicant: The Curators of the University of Missouri, Columbia, MO (US)

(72) Inventor: Kelly O. Homan, Rolla, MO (US)

(73) Assignee: The Curators of the University of Missouri, Columbia, MO (US)

(21) Appl. No.: 18/580,675

(22) PCT Filed: Jul. 20, 2022
(86) PCT No.: PCT/US2022/037725

§ 371 Date: Jan. 19, 2024

Related U.S. Application Data
(60) Provisional application No. 63/224,369, filed on Jul. 21, 2021.

(51) Int. Cl. F24H 1/20; F24H 9/00; F24H 9/20

(52) U.S. Cl. CPC F24H 1/202; F24H 9/0021; F24H 9/2021; F24H 2250/02

(57) ABSTRACT

A storage fluid heater and methods of its use are disclosed for storing, heating, and/or delivering water. The storage fluid heater includes a secondary structure with a pump and heat transfer surface to pump up colder water from the bottom of the tank that has entered via the fluid inlet, heat the water, and release the water at the top of the tank to be withdrawn via the fluid outlet.

### FIELD

Aspects of the present disclosure relate to storage fluid heaters, particularly storage water heaters.

### BACKGROUND

Known storage water heating systems, include, for example, electric resistance water heaters (ERWH), combustion-fired water heaters (CFWH), and heat pump water heaters (HPWH) as well as less widely used forms such as solar water heaters (SWH).

All implementations of storage water heating systems available in the market, across forms (electric resistance, combustion-fired, heat pump), allow for large-scale, gravity-driven thermal mixing. Conventional wisdom is that this large-scale mixing is unavoidable but also desirable to a certain extent. This is because thermal mixing ensures temperature uniformity within the stored volume. However, large-scale thermal mixing can be detrimental to both short-and long-term storage water heating performance.

Previous attempts to overcome this problem have included introducing a divider such that the energy addition surfaces are isolated from the larger storage volume and using gravity to provide the circulation of the stored water past the heat addition surfaces contained in the so-called internal small volume. In these past attempts, special allowance had to be made to accommodate the variability of the gravitational “pumping power” as the stored volume reached a fully heated condition. In short, the thermosiphon-based system could not produce a fully-charged storage volume of nominally-uniform temperature. A nominally-uniform stored volume water temperature at the end of the heating process is the usual result in water heating systems that make no effort to limit the thermal mixing caused by the energy addition process.

To compensate for this, previous attempts have envisioned a second amount of energy addition surfaces, not inside the so-called internal small volume that could be used to complete the charging (heating) process. One problem with this, especially for ERWH, is that the system showed sensitivity to inlet temperature if the energy addition power was not modulated. For application to HPWH systems, the disadvantage is that the extra heat addition surface area required for the HPWH made it more difficult for the passive pumping power of gravity to circulate the water through the internal small volume at desirable rates. This concern is particularly acute for HPWH since the surface-to-fluid temperature difference is lower than for ERWH, thereby requiring more surface ara to achieve desired total energy transfer rates.

Thus, there remains a need in storage fluid heaters that circulate water through a heated internal small volume to be able to reach desirable rates of flow when the passive gravitational pumping power is not sufficient.

### SUMMARY

Aspects of the present disclosure are directed to a storage fluid heater for water storage, heating, and delivery. Aspects are further directed to methods of using these storage fluid heaters to provide hot water. Water enters the tank through a fluid inlet at the bottom of the tank, and water is pulled up through a secondary structure via a pump, where it is heated and subsequently released at the top of the tank. Heated water is then removed from the tank for use via a fluid outlet.

In one aspect, a storage fluid heater comprises a primary structure defining a first interior for holding a first volume of a fluid. A secondary structure defines a secondary interior for holding a second volume of the fluid. The secondary interior is in fluid communication with the first interior. A fluid inlet supplies fluid into the first interior and/or second interior. A fluid outlet enables withdrawing of fluid from the first interior and/or second interior. A heat transfer surface supplies heat into the second interior. A pump is in fluid communication with the first interior and the second interior. The pump is configured to circulate fluid between the first interior and the second interior.

In another aspect, a method for heating a fluid in a storage fluid heater comprises receiving fluid to a primary structure defining a first interior for holding a first volume of the fluid; receiving the fluid to a secondary structure, wherein the secondary structure defines a secondary interior for holding a second volume of the fluid and wherein the secondary interior is in fluid communication with the first interior. The method further comprises supplying heat to the second volume of fluid; and pumping at least a portion of the second volume fluid to the first interior to increase and/or maintain the temperature of the first volume of fluid.

Other objects and features will be in part apparent and in part pointed out hereinafter.

### BRIEF DESCRIPTION OF THE SEVERAL VIEWS OF THE DRAWING

FIG. 1 is a cross-section illustration of a storage fluid heater according to one embodiment of the present disclosure.

FIG. 2 is a cross-section illustration of a storage fluid heater according to another embodiment of the present disclosure.

FIG. 3 is a cross-section illustration of a storage fluid heater according to another embodiment of the present disclosure.

Corresponding reference characters indicate corresponding parts throughout the drawings.

### DETAILED DESCRIPTION

The present disclosure is directed to water storage, heating, and delivery. In one embodiment, water enters a storage fluid heater, such as at the bottom, and is pumped into (e.g., up into) a second interior through a secondary structure where it is heated. The heated water is released at the top of the tank, where it remains substantially unmixed with the main volume of the first interior. Heated water leaves the storage fluid heater via the top, and at least of a portion of this heated water is the heated water that passed through the secondary structure.

Aspects of the present disclosure overcome previously identified issues when passive gravitational pumping power is not sufficient by the introduction of an active fluid pump, which allows direct control of the circulation flow rate through the internal second interior. This allows the outlet temperature to be readily controlled and allow a higher level of heat pump efficiency, since a higher circulating flow rate produces higher heat transfer coefficients and can accommodate lower surface-to-fluid temperature differences. Lower usable surface-to-fluid temperature differences means that the heat pump compressor can operate at a lower pressure lift. In a heat pump system, the compressor power dominates the electrical requirement of the overall system and a lower pressure lift therefore translates directly to lower energy consumption and higher overall system efficiencies. Aspects of the present disclosure also result in an increase in performance compared to conventional storage fluid heaters that are otherwise identical in metrics such as the amount of hot water than can be withdrawn during a set time period. This leads to requiring a smaller storage fluid heater to produce the same amount of hot water over a set time.

One aspect of the present disclosure is directed to a storage fluid heater comprising a primary structure defining a first interior for holding a first volume of a fluid; a secondary structure, wherein the secondary structure defines a secondary interior for holding a second volume of the fluid and wherein the secondary interior is in fluid communication with the first interior; a fluid inlet for supplying fluid into the first interior and/or second interior; a fluid outlet for withdrawing fluid from the first interior and/or second interior; a heat transfer surface to supply heat into the second interior; and a pump in fluid communication with the first interior and the second interior, wherein the pump is configured to circulate fluid between the first interior and the second interior.

In certain embodiments, the primary structure comprises an insulated tank.

In certain embodiments, the secondary structure comprises a conduit. In certain embodiments, the conduit is a tube. In certain embodiments, the conduit further comprises an insulated wire that delivers electrical energy to the pump.

In certain preferred embodiments, the secondary structure comprises a low to moderate thermal conductivity to maintain the warmer temperature of the second interior. In certain embodiments, the secondary structure comprises plastic.

The heat transfer surface may produce heat that is then transferred to the fluid of the second interior. In certain embodiments, the heat transfer surface of the storage fluid heater comprises a heating element. In certain embodiments, the heat transfer surface of the storage fluid heater comprises an electrical resistance heating element. In certain embodiments, the heat transfer surface of the storage fluid heater comprises a high temperature heating surface of a heat pump. In certain embodiments, the heat transfer surface comprises a combination of different heat sources, such as a high temperature heating surface of a heat pump and an electrical resistance heating element. Other heating elements are within the scope of the present disclosure such as a gas-fired heating element.

The position of the second interior compared to the first interior can vary. In certain embodiments, at least a portion of the second interior of the storage fluid heater is positioned within the first interior of the primary structure. In certain embodiments, the second interior of the storage fluid heater is positioned entirely within the first interior of the primary structure. In certain embodiments, at least a portion of the second interior of the storage fluid heater is positioned outside of the first interior of the primary structure.

Similarly, the position of the heat transfer surface compared to the second interior can vary. In certain embodiments, at least a portion of the heat transfer surface of the storage fluid heater is positioned within the second interior. In certain embodiments, the heat transfer surface of the storage fluid heater is positioned entirely within the second interior. In certain embodiments, the heat transfer surface of the storage fluid heater that is positioned entirely within or at least partially positioned within the second interior is the only heating element in the storage fluid heater. In certain embodiments, a heat transfer surface of the storage fluid heater is not positioned in the first interior. In certain embodiments, the storage fluid heater further comprises a heat transfer surface positioned in the first interior.

In certain embodiments, the storage fluid heater further comprises one or more thermostats configured to control the temperature of the heat transfer surface. In certain embodiments, the one or more thermostats may be used to modulate the energy transfer from the heated surface and/or the flow rate produced by the pump. For example, in some embodiments, the storage fluid heater comprises at least one thermostat at least partially positioned in the first interior. In another embodiment, the storage fluid heater comprises at least one thermostat at least partially positioned in the second interior. In a further embodiment, the storage fluid heater comprises at least one thermostat at least partially positioned in the first interior and at least one thermostat at least partially positioned in the second interior. In yet another embodiment, the storage fluid heater comprises at least one thermostat positioned outside of the first and/or second interior.

The position of the pump can also vary. In certain embodiments, the pump of the storage fluid heater is positioned at a lower portion of the secondary structure. In certain embodiments, the relative positioning of the heat transfer surface and the pump can be anywhere in the heating circuit, in any order.

The pump can be configured to operate in several different ways. In certain embodiments, the pump is configured to pump fluid during withdrawal of fluid through the fluid outlet. In certain embodiments, the pump is controlled to also operate when fluid is not being withdrawn through the fluid outlet. For example, the pump may be operated to move fluid to return the first volume to a suitably heated condition after withdrawal of the fluid through the fluid outlet is terminated. In another example, the pump may be controlled to delay moving fluid when fluid starts to be withdrawn through the fluid outlet so that, for example, the pump need not turn on for only a small amount of water being withdrawn from the first volume (i.e., a small volume usage as when quickly washing hands). In certain embodiments, the pump is configured to pump fluid while fluid is supplied through the fluid inlet to the first interior or second interior. In certain embodiments, the pump is controlled via a simple on-off control. In certain embodiments, the pump is controlled relative to the fluid flow rate through the second interior, in concert with the heat transfer rate across the heated surface enclosed in the second interior.

The ratios of the volumes of the first and second interiors can also vary. In certain embodiments the storage fluid heater has a volumetric ratio of the first volume to the second volume of about 2:1 or greater, about 3:1 or greater, about 4:1 or greater, about 5:1 or greater, about 10:1 or greater, or about 25:1 or greater. In certain embodiments, the storage fluid heater has a volumetric ratio of the first volume to the second volume from about 2:1 to about 100:1, from about 2:1 to about 50:1, from about 2:1 to about 25:1, from about 5:1 to about 100:1, from about 5:1 to about 50:1, or from about 5:1 to about 25:1.

Another aspect of the disclosure is directed to a method for heating a fluid in a storage fluid heater, the method comprising receiving fluid to a primary structure defining a first interior for holding a first volume of the fluid; receiving the fluid into a secondary structure, wherein the secondary structure defines a secondary interior for holding a second volume of the fluid and wherein the secondary interior is in fluid communication with the first interior; supplying heat to the second volume of fluid; and pumping at least a portion of the second volume fluid to the first interior to increase and/or maintain the temperature of the first volume of fluid.

In certain embodiments, the method further comprises supplying heat to the second interior when water is drawn from the storage fluid heater. In certain embodiments, the method further comprises supplying heat to the second interior when water is received to the storage fluid heater.

In certain embodiments, the method further comprises controlling the temperature of the fluid according to a control scheme wherein the temperature of the first volume of fluid is maintained at a set temperature, within a set temperature range, or a desirable variation of temperature (e.g., a stably-stratified vertical temperature variation within the first volume of fluid). In some embodiments, a stably-stratified vertical temperature variation within the first volume of fluid comprises a series of stratified temperature zones that differ by 1° C. or more, 2° C. or more, 5° C. or more, or 10° C. or more. For example, from about 1° C. to about 10° C., from about 2° C. to about 10° C., or from about 5° C. to about 10° C. In certain embodiments, the method further comprises controlling the temperature of the fluid according to a control scheme wherein the temperature of the first volume of fluid is adapted to a usage pattern of a user. In some embodiments, the method comprises controlling the temperature of the fluid according to a control scheme wherein the temperature of the first volume of fluid is adapted to variations in the requirements of a utility supplier. In another embodiment, the method comprises controlling the temperature of the fluid according to a control scheme wherein the temperature of the first volume of fluid is adapted to variations in the available energy supply. In certain embodiments, the method further comprises controlling the temperature of the fluid according to a control scheme wherein the temperature of the first volume of fluid is increased to a set temperature as fast as efficiently possible.

In certain embodiments, the storage fluid heater of the method comprises the storage fluid heater of any of the aforementioned embodiments of storage fluid heaters.

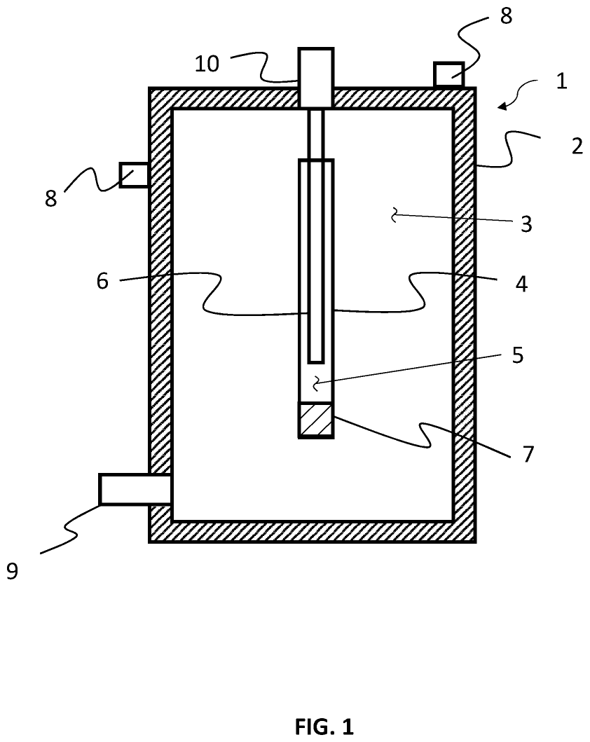

Referring to FIG. 1, one embodiment of a storage fluid heater is generally indicated at (1). The storage fluid heater (1) comprises a primary structure (2), such as a tank, with a first interior (3) holding a first volume of fluid and a secondary structure (4), such as a conduit, tube or the like, with a second interior (5) holding a second volume of fluid. In the illustrated embodiment, the secondary structure (4) is completely inside of the primary structure (2). The secondary structure (4) (e.g., second interior (5)) is generally elongate and extends generally vertically. The second interior (5) includes an open lower end and an open upper end disposed above the open lower end. The open upper end is adjacent (e.g., at the top of) the first interior (3). Both the open lower and upper ends of the second interior (5) are in fluid communication with the first interior (3). This allows water to flow into the secondary structure (4) (e.g., second interior (5)) from the first interior (3) through the open lower end and out into the first interior through the open upper end.

In this embodiment, the heat transfer surface (6) comprises an electrical resistance heating element. The storage fluid heater (1) includes a pump (7) located at the base or lower end of the secondary structure (4). The pump (7) moves water through the second interior (5) (e.g., into the open lower end and out of the open upper end). Preferably, at least one thermostat (8) is located on the exterior of the storage fluid heater (1). The thermostat (8) controls the heat output of the heat transfer surface (6) (e.g., controls the electrical resistance heating element) to control the temperature of the heated water.

In operation, water enters the first interior (3) of the primary structure (2) through a fluid inlet (9) of the storage water heater (1). After the water is in the first interior (3), the water is pumped through the secondary structure (4), by the pump (7), where the water is heated by the heat transfer surface (6). The heated water is then released or exits the secondary structure (4) adjacent (e.g., at the top of) the first interior (3) but remains substantially unmixed with the main volume of fluid in the first interior. Heated water exits the storage fluid heater (1) via a fluid outlet (10) at the top of the storage fluid heater. The fluid outlet (10) is disposed on the primary structure (2) (broadly, outside the first interior (3)) and is preferably aligned (e.g., vertically aligned) with the secondary structure (4) (e.g., the open upper end of the second interior (5)) so as to minimize the distance between the secondary structure and the fluid outlet. Because the heated water exits the secondary structure (4) adjacent the top of the first interior (3), a portion of the water exiting the fluid outlet (10) comes from the water heated via passage through the secondary structure and the rest comes from the main volume of the first interior. In other words, at least a portion of the heated water exiting the secondary structure (4) flows directly to the fluid outlet (10) (a short distance through the first interior (3)) when water exits the storage water heater (1) through the fluid outlet. Preferably the fluid outlet (10) is aligned with the secondary structure (4) in the direction the water generally exits the secondary structure so that the heated water is already flowing toward the fluid outlet upon exiting the second interior (5).

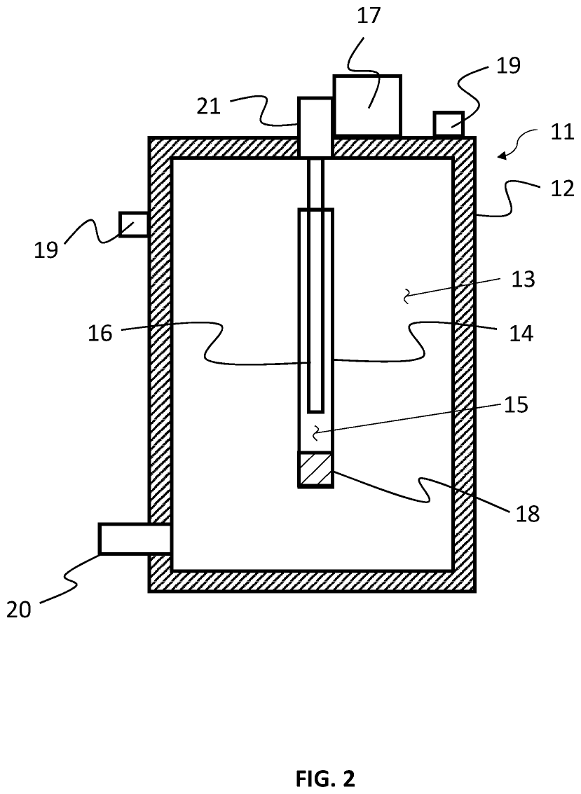

Referring to FIG. 2, another embodiment of a storage fluid heater is generally indicated at (11). Similar to the storage fluid heater (1) of FIG. 1, the storage fluid heater (11) of FIG. 2 comprises a primary structure (12), such as a tank, with a first interior (13) holding a first volume of fluid and a secondary structure (14), such as a conduit, tube or the like, with a second interior (15) holding a second volume of fluid. In the illustrated embodiment, the secondary structure (14) is completely inside of the primary structure (12). The secondary structure (14) (e.g., second interior (15)) is generally elongate and extends generally vertically. The second interior (15) includes an open lower end and an open upper end disposed above the open lower end. The open upper end is adjacent (e.g., at the top of) the first interior (13). Both the open lower and upper ends of the second interior (15) are in fluid communication with the first interior (13). This allows water to flow into the secondary structure (14) (e.g., second interior (15)) from the first interior (13) through the open lower end and out into the first interior through the open upper end.

In this embodiment, the storage fluid heater (11) includes a heat transfer surface (16) that comprises a high temperature heating surface of a heat pump (17). The heat pump (17) may include components located outside the primary structure (12) but operatively connected to the heat transfer surface (16). The storage fluid heater (11) includes a pump (18) located at the base or lower end of the secondary structure (14). The pump (18) moves water through the second interior (15) (e.g., into the open lower end and out of the open upper end). Preferably, at least one thermostat is located on the exterior of the storage fluid heater (11). The thermostat (19) controls the heat output of the heat transfer surface (16) (e.g., controls the heat pump (17)) to control the temperature of the heated water.

In operation, water enters the first interior (13) of the primary structure (12) through a fluid inlet (20) of the storage water heater (11). After the water is in the first interior (13), the water is pumped through the secondary structure (14), by the pump (18), where the water is heated by the heat transfer surface (16). The heated water is then released or exits the secondary structure (14) adjacent (e.g., at the top of) the first interior (13) but remains substantially unmixed with the main volume of fluid in the first interior. Heated water exits the storage fluid heater (11) via a fluid outlet (21) at the top of the storage fluid heater. The fluid outlet (21) is disposed on the primary structure (12) (broadly, outside the first interior (13)) and is preferably aligned (e.g., vertically aligned) with the secondary structure (14) (e.g., the open upper end of the second interior (15)) so as to minimize the distance between the secondary structure and the fluid outlet. Because the heated water exits the secondary structure (14) adjacent the top of the first interior (13), a portion of the water exiting the fluid outlet (21) comes from the water heated via passage through the secondary structure and the rest comes from the main volume of the first interior. In other words, at least a portion of the heated water exiting the secondary structure (14) flows directly to the fluid outlet (21) (a short distance through the first interior (13)) when water exits the storage water heater (11) through the fluid outlet. Preferably the fluid outlet (21) is aligned with the secondary structure (14) in the direction the water generally exits the secondary structure so that the heated water is already flowing toward the fluid outlet upon exiting the second interior (15).

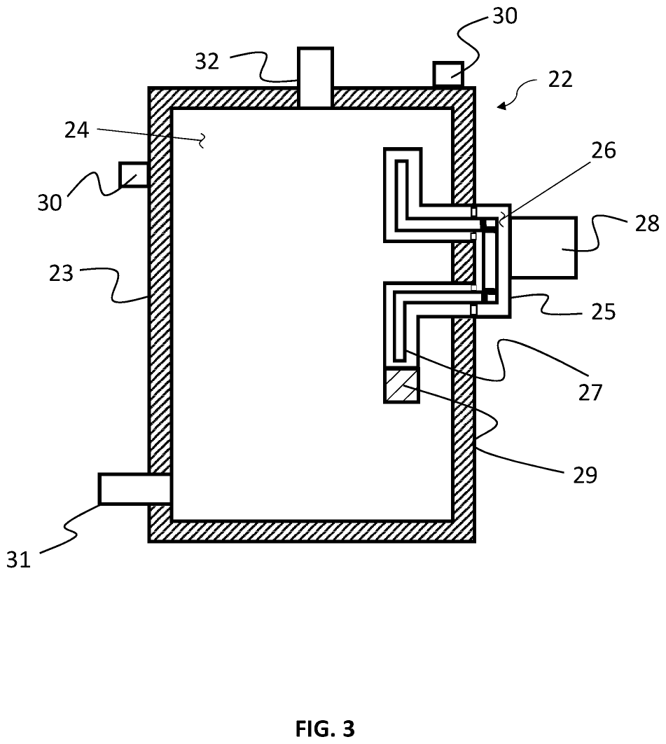

Referring to FIG. 3, another embodiment of a storage fluid heater is generally indicated at (22). Similar to the storage fluid heater (1) of FIG. 1 and the storage fluid heater (11) of FIG. 2, the storage fluid heater (22) comprises a primary structure (23), such as a tank, with a first interior (24) holding a first volume of fluid and a secondary structure (25), such as a conduit, tube or the like, with a second interior (26) holding a second volume of fluid. In this embodiment, the secondary structure (25) is partially outside of the primary structure (23). The secondary structure (25) is generally elongate, but instead of defining a generally linear extending second interior as the secondary structures (4, 14) described above, the secondary structure of the storage fluid heater of FIG. 3 includes a plurality of segments (e.g., linear segments) that extend in different directions (such as into and out of the primary structure (23)). The second interior (26) includes an open lower end and an open upper end disposed above the open lower end. The open upper end is adjacent (e.g., at the top of) the first interior (24). Both the open lower and upper ends of the second interior (26) are in fluid communication with the first interior (24). This allows water to flow into the secondary structure (25) (e.g., second interior (26) from the first interior (24) through the open lower end and out into the first interior through the open upper end.

In this embodiment, the storage fluid heater (22) includes a heat transfer surface (27) that comprises a high temperature heating surface of a heat pump (28). The heat pump (28) may include components located outside the primary structure (23) but operatively connected to the heat transfer surface (27). In the illustrated embodiment, the heat transfer surface (27) is partially disposed inside and outside the primary structure (23). The storage fluid heater (22) includes a pump (29) located at the base or lower end of the secondary structure (25). The pump (29) moves water through the second interior (25) (e.g., into the open lower end and out of the open upper end). Preferably, at least one thermostat (30) is located on the exterior of the storage fluid heater (22). The thermostat (30) controls the heat output of the heat transfer surface (27) (e.g., controls the heat pump (28)) to control the temperature of the heated water.

In operation, water enters the first interior (24) of the primary structure (23) through a fluid inlet (31) of the storage water heater (22). After the water is in the first interior (24), the water is pumped through the secondary structure (25), by the pump (29), where the water is heated by the heat transfer surface (27). The heated water is then released or exits the secondary structure (25) adjacent (e.g., at the top of) the first interior (24) but remains substantially unmixed with the main volume of the fluid in the first interior. Heated water exits the storage fluid heater (22) via a fluid outlet (32) at the top of the storage fluid heater. The fluid outlet (32) is disposed on the primary structure (23) (broadly, outside the first interior 24)). In one embodiment, the fluid outlet (32) is preferably aligned (e.g., vertically aligned) with the secondary structure (25) (e.g., the open upper end of the second interior (26)) so as to minimize the distance between the secondary structure and the fluid outlet. Because the heated water exits the secondary structure (25) adjacent the top of the first interior (24), a portion of the water exiting the fluid outlet (32) comes from the water heated via passage through the secondary structure and the rest comes from the main volume of the first interior. In other words, at least a portion of the heated water exiting the secondary structure (25) flows directly to the fluid outlet (32) (a short distance through the first interior (24)) when water exits the storage water heater (22) through the fluid outlet. Preferably the fluid outlet (32) is aligned with the secondary structure (25) in the direction the water generally exits the secondary structure so that the heated water is already flowing toward the fluid outlet upon exiting the second interior (26).

In all embodiments of the storage water heater (1, 11, 22), the fluid (e.g., water) drawn into the heating circuit (e.g., the secondary structure (4, 14, 25) is from the lower portion of the stored volume (e.g., first interior (3, 13, 24)) and returned to the upper portion of the stored volume. This maintains a gravitationally stable temperature (density) profile. In a similar way, the hot water is withdrawn from the top of the stored volume via the fluid outlet (10, 21, 32) and the cold or non-heated water is provided at the bottom of the stored volume via the water inlet (9, 20, 31) so to preserve overall gravitational stability.

For the storage water heaters (11, 22) with a heat pump (17, 28) (FIG. 2 and FIG. 3), the heat source (e.g., the heat transfer surface 16, 27) is the condenser of the heat pump. As mentioned above, the remaining components of the heat pump system (compressor, evaporator, fan and other components) would generally be disposed outside of the primary structure (23) (e.g., the primary interior (24)) but in close proximity or integrated within an encompassing shell or package. For each heat pump (17, 28), heat is drawn from a suitable source (typically, the ambient air of the space in which the storage water heater (11, 22) is located) and is connected to an electrical source to provide power for the operation of the compressor, fan and other miscellaneous components of each heat pump.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

1. A storage fluid heater comprising:
a primary structure defining a first interior for holding a first volume of a fluid;
a secondary structure, wherein the secondary structure defines a secondary interior for holding a second volume of the fluid and wherein the secondary interior is in fluid communication with the first interior;
a fluid inlet for supplying fluid into the first interior and/or second interior;
a fluid outlet for withdrawing fluid from the first interior and/or second interior,
a heat transfer surface to supply heat into the second interior, and
a pump in fluid communication with the first interior and the second interior, wherein the pump is configured to circulate fluid between the first interior and the second interior.

2. (canceled)

3. The storage fluid heater of claim 1, wherein the secondary structure comprises a conduit.

4. (canceled)

5. (canceled)

6. The storage fluid heater of claim 1, further comprising a thermostat configured to control the temperature of the heat transfer surface.

7. The storage fluid heater of claim 1, wherein the pump is positioned at a lower portion of the secondary structure.

8. The storage fluid heater of claim 1, wherein the volumetric ratio of the first volume to the second volume is about 2:1 about or greater, about 3:1 or greater, about 4:1 or greater, about 5:1 or greater, about 10:1 or greater, or about 25:1 or greater.

9. (canceled)

10. The storage fluid heater of claim 1, wherein the heat transfer surface comprises a heating element.

11. (canceled)

12. (canceled)

13. The storage fluid heater of claim 1, wherein at least a portion of the heat transfer surface is positioned within the second interior.

14. (canceled)

15. The storage fluid heater of claim 1, wherein a heat transfer surface is not positioned in the first interior.

16. (canceled)

17. The storage fluid heater of claim 1, further comprising a heat transfer surface positioned in the first interior.

18. The storage fluid heater of claim 1, wherein at least a portion of the second interior is positioned within the first interior of the primary structure.

19. The storage fluid heater of claim 1, wherein at least a portion of the second interior is positioned outside of the first interior of the primary structure.

20. The storage fluid heater of claim 1, wherein the second interior is positioned entirely within the first interior of the primary structure.

21. A method for heating a fluid in a storage fluid heater, the method comprising:
receiving fluid to a primary structure defining a first interior for holding a first volume of the fluid;
receiving the fluid to a secondary structure, wherein the secondary structure defines a secondary interior for holding a second volume of the fluid and wherein the secondary interior is in fluid communication with the first interior,
supplying heat to the second volume of fluid; and
pumping at least a portion of the second volume fluid to the first interior to increase and/or maintain the temperature of the first volume of fluid.

22. The method of claim 21, further comprising supplying heat to the second interior when water is drawn from the storage fluid heater.

23. The method of claim 21, further comprising supplying heat to the second interior when water is received to the storage fluid heater.

24. (canceled)

25. The method of claim 21, further comprising controlling the temperature of the fluid according to a control scheme wherein the temperature of the first volume of fluid is maintained at a set temperature or within a set temperature range or a desirable variation of temperature.

26. The method of claim 21, further comprising controlling the temperature of the fluid according to a control scheme wherein the temperature of the first volume of fluid is adapted to a usage pattern of a user.

27. The method of claim 21, further comprising controlling the temperature of the fluid according to a control scheme wherein the temperature of the first volume of fluid is increased to a set temperature on an as fast as efficiently possible basis.

28. The method of claim 21, further comprising controlling the temperature of the fluid according to a control scheme wherein the temperature of the first volume of fluid is adapted to variations in the requirements of a utility supplier.

29. The method of claim 21, further comprising controlling the temperature of the fluid according to a control scheme wherein the temperature of the first volume of fluid is adapted to variations in the available energy supply.
